(19) United States
(12) Patent Application Publication
(10) Pub. No.: US 2016/0114725 A1
(43) Pub. Date: Apr. 28, 2016

(54) Method for a Vehicle Misfuelling Alert System

(71) Applicant: L. Derek Green, Gainesville, TX (US)

(72) Inventor: L. Derek Green, Gainesville, TX (US)

(21) Appl. No.: 14/922,843

(22) Filed: Oct. 26, 2015

Related U.S. Application Data
(60) Provisional application No. 62/068,325, filed on Oct. 24, 2014.

(51) Int. Cl. B60Q 9/00; B60K 15/03

(52) U.S. Cl. CPC B60Q 9/00; B60K 15/03; B60K 2015/0321

(57) ABSTRACT

A method for a vehicle misfuelling alert system warns and prevents the use or possible use of regular fuel in a diesel vehicle. The alert system includes a sensor, a microprocessor, and an alert device. The sensor and the alert device are integrated into the diesel vehicle as well as electronically connected to each other through the microprocessor. The method includes capturing raw data through the sensor, wherein the raw data corresponds to a current use or potential use of regular fuel within the diesel vehicle. The raw data is then sent from the sensor to the microprocessor for analysis. The microprocessor compares the raw data against allowable conditions for the refueling the diesel vehicle. A trigger command is generated by the microprocessor, if the raw data does not match the allowable conditions. The trigger command is then sent to and executed by the alert device.

The current application claims a priority to the U.S. Provisional Patent application Ser. No. 62/068,325 filed on Oct. 24, 2014.

### FIELD OF THE INVENTION

The present invention relates generally to a method for prevent the misfuelling of an automotive vehicle. More specifically, the present invention is the method for a vehicle misfuelling alert system which alerts and or prevents a motorist from using the wrong type of fuel, gasoline, for his or her diesel vehicle.

### BACKGROUND OF THE INVENTION

A diesel engine is an internal combustion engine which uses the heat produced by the compression of air to ignite fuel inside a cylinder. This type of engine is only compatible with a specific fuel type, in particular diesel fuel. The use of other types of fuels, gasoline for example, in a diesel engine will cause increased wear and tear to the components, subpar performance, and in extreme cases catastrophic damage to the engine. For example, if a diesel vehicle is fueled up with gasoline then there is a good chance of damage to the emission control components, the valve train, and the fuel pump. Additionally, because gasoline is designed to resist auto-ignition it will either not ignite in a diesel engine or ignite at an improper time, causing a shock wave that can and most likely will cause damage to the pistons, wrist pins, and connecting rods. This can cost the owner hundreds to thousands of dollars in repairs bills. Veteran drivers of diesel vehicles are consciously aware of these consequences and usually pay attention when fueling up their vehicles. Drivers of non-diesel vehicles, on the other hand, often need a reminder of this if and when they begin driving a diesel vehicle.

The present invention is a method for warning, reminding or alerting the personnel that only diesel fuel may be used for the diesel vehicle. This is useful even for veteran owners of diesel vehicles as it is easy to get distracted and run on autopilot when performing trivial tasks such as fueling up one's vehicle. This alert is by sight or sound using lights and/or audible speaker. The method of the present invention utilizes an electronic device that can be mounted in various locations, fuel door, fuel filler cap, fuel filler tube, fuel compartment, or ground, anywhere that a person fueling could be alerted. The electronic device is turned on through sensors or switches, light, motion, proximity, limit, etc. Another sight model projects a laser image on the side of the vehicle near the fuel compartment, stating “diesel fuel only” or any term that would prevent the misfuel from happening. The electronic device may be battery powered, vibration powered, or hard wired to the battery of the vehicle. The electronic device has many functions to control the light and sound, through a programmable chip. A variety of methods may be used to mount the electronic device to the diesel vehicle. Methods include, but are not limited to magnets, two-sided tape, or factory installed on the vehicle, in the fuel door compartment to be more specific.

### BRIEF DESCRIPTION OF THE DRAWINGS

FIG. 1 is a flow chart of the overall process of the present invention.

FIG. 2 is a flow chart depicting the steps necessary for utilizing a light sensor as one of the at least one sensors.

FIG. 3 is a flow chart depicting the steps necessary for utilizing a distance-measuring sensor as one of the at least one sensors.

FIG. 4 is a flow chart depicting the steps necessary for utilizing a fuel composition sensor as one of the at least one sensors.

FIG. 5 is a flow chart depicting the steps necessary for utilizing a visual alert device as one of the at least one alert devices.

FIG. 6 is a flow chart depicting the steps necessary for utilizing an audible speaker as one of the at least one alert devices.

FIG. 7 is a flow chart depicting the steps necessary for utilizing an alarm system of the diesel vehicle as one of the at least one alert devices.

FIG. 8 is a flow chart depicting the steps necessary for a user interface component of the present invention.

### DETAIL DESCRIPTIONS OF THE INVENTION

All illustrations of the drawings are for the purpose of describing selected versions of the present invention and are not intended to limit the scope of the present invention.

The present invention generally relates to a warning and alert system which prevents the misfuelling of automotive vehicles. More specifically, the present invention is a method and system which is integrated into an automotive vehicle that detects refueling actions and warns, reminds or alerts the personnel fueling the automotive vehicle that only a specific fuel type may be used, preventing the misfuelling of the automotive vehicle. The system includes the physical components necessary for the functions of the present invention. The method is a series of steps executed by the system in order to identify refueling actions and activate different kinds of alert responses. The present invention may be implemented two main forms, an integrated embodiment and a retrofit embodiment. In the integrated embodiment, the system of the present invention is integrated into the automotive vehicle during the design and manufacturing processes. In the retrofit embodiment, the system of the present invention is a retrofit apparatus that is installed into the automotive vehicle.

The present invention is preferably integrated into and is configured for a diesel vehicle. The system of the present invention includes an at least one sensor, an at least one alert device, a microprocessor, and a power source. The sensor(s) is integrated into the diesel vehicle and is used to monitor operational conditions of the diesel vehicle and environmental conditions around the diesel vehicle which indicates a current use or potential use of regular fuel, or other incompatible fuel types, within the diesel vehicle. Current use of regular fuel specifically refers to fuel flowing into the gas tank of the diesel vehicle that is not compatible with the diesel vehicle, in particular regular fuel. Alternatively, potential use of regular fuel refers to a motorist beginning refueling actions; refueling actions include, but are not limited to, opening a fuel filler housing of the diesel vehicle, walking past the fuel filler housing, and inserting a fuel nozzle into a filler neck of the diesel vehicle. Different kinds of sensors that can be used for the present invention include, but are not limited to, a light sensor, a distance-measuring sensor, and a fuel composition sensor.

The alert device(s) is used to convey a warning, a reminder, or an alert to the motorist by sight or sound. The warning, reminder, or alert are designed to convey to the motorist which type of fuel should be used with the automotive vehicle. The microprocessor gathers and analyzes raw data from the sensor(s) in order to identify the current use or potential use of regular fuel within the diesel vehicle, and if necessary set off the alert device in response. The microprocessor is electronically connected to the sensor(s) and to the alert device(s). The power source provides the necessary electric energy for the system of the present invention and, thus, is electrically connected to the microprocessor, the sensor(s), the alert device(s), and any other necessary electric components of the present invention. In one embodiment of the present invention, the power source is a portable battery that is integrated into the diesel vehicle, near the sensor(s) and the alert device(s). In another embodiment of the present invention, the battery of the diesel vehicle is used as the power source.

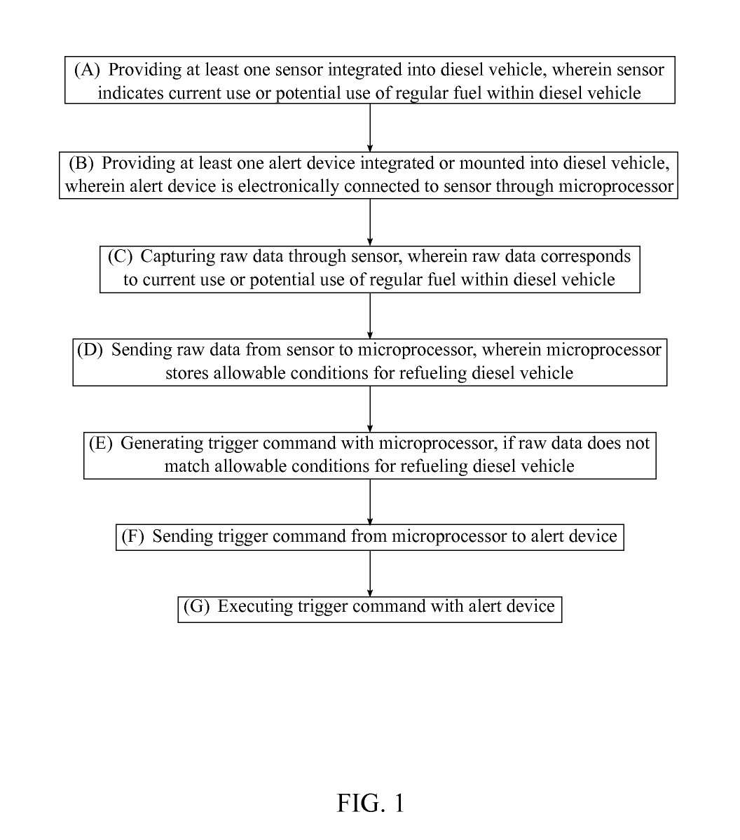

Referring to FIG. 1, the method of the present invention follows an overall process that gathers, analyzes, and responds to the raw data gathered by the sensor(s). The overall process begin with the constituents of the system being integrated into the diesel vehicle. This includes the sensor(s) being integrated or mounted into the diesel vehicle (Step A). Additionally, the alert device is also integrated or mounted into the diesel vehicle (Step B), wherein the alert device(s) is electronically connected to the sensor(s) through the microprocessor. Furthermore, the microprocessor and the power source are also integrated into the diesel vehicle. Next, raw data is captured through the sensor(s), wherein the raw data corresponds to the current use or potential use of regular fuel within the diesel vehicle (Step C). The type of raw data is dependent of the type of device used for the sensor component. The raw data is then sent from the sensor(s) to the microprocessor for analysis (Step D). The analysis includes comparing the raw data against allowable conditions for refueling the diesel vehicle and determines if determine if the raw data meets the set of allowable conditions. The allowable conditions are stored on the microprocessor so that the allowable conditions are readily available when the analysis needs to be completed. If the raw data does not match the allowable conditions, then the microprocessor generates a trigger command (Step E). Allowable conditions describe conditions in which there is no possibility that regular fuel will be used to refuel the diesel vehicle. If the raw data does meet the allowable conditions, then the microprocessor does not generate the trigger command and the present invention continues to gather more raw data. The trigger command may include a variety of procedures and signals, each of which is associated with a specific type of alert device and a specific action. The trigger command is then sent from the microprocessor to the alert device (Step F). Finally, the trigger command is executed by the alert device in order to alert the motorist (Step G).

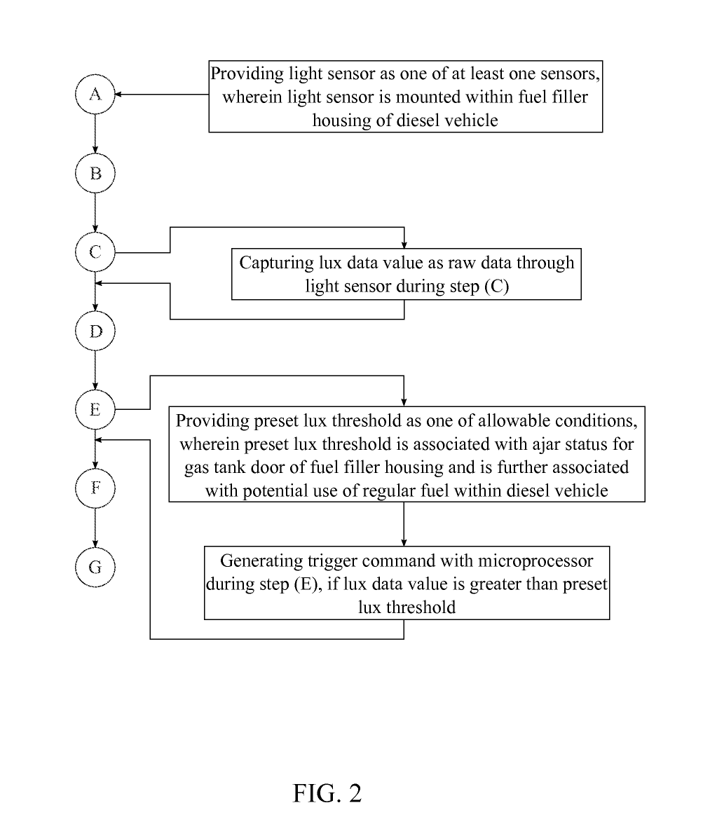

In one embodiment of the present invention, the light sensor is used as one of the at least one sensors. In this embodiment, the light sensor is mounted within the fuel filler housing of the diesel vehicle and is used to determine when a gas tank door of the fuel filler housing is opened, which indicates that the motorist is attempting to refuel the diesel vehicle. The process, depicted in FIG. 2, includes the light sensor capturing a lux data value as the raw data during step (C); lux data value measures illuminance and luminous emittance, intensity of light which passes through a surface. This embodiment includes a preset lux threshold as one of the allowable conditions, wherein the preset lux threshold is associated with an ajar status for the gas tank door and is further associated with the potential use of regular fuel within the diesel vehicle. More specifically, the preset lux threshold indicates that the intensity of the light shining on the light sensor is high enough to ascertain that the gas tank door is positioned into the ajar status. This means that the motorist is about to refuel the diesel vehicle. After the lux value data is captured, it is then compared against the preset lux threshold. If the lux value data is greater than the preset lux threshold, then the system generates the trigger command with the microprocessor during step (E) in order to signal the motorist of the potential use of regular fuel within the diesel vehicle.

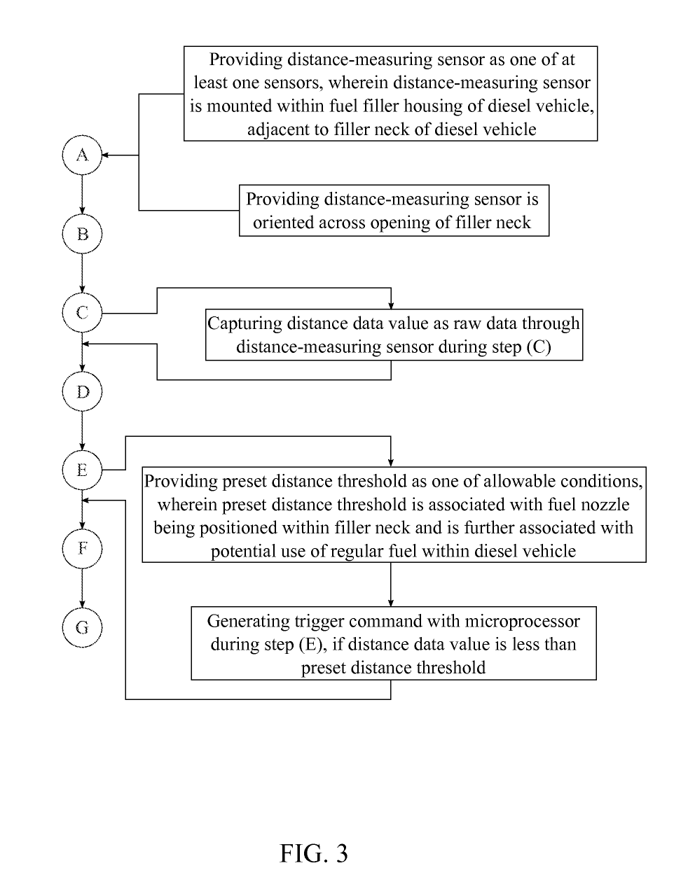

Referring to FIG. 3, in another embodiment of the present invention, the distance-measuring sensor is used as one of the at least one sensors. In this embodiment, the distance-measuring sensor is mounted within the fuel filler housing, adjacent to a filler neck of the diesel vehicle. More specifically, the distance-measuring sensor is oriented across an opening of the filler neck. The distance-measuring sensor determines the distance to the closest object/surface in the line of sight of the distance-measuring sensor, allowing the present invention to determine when a fuel nozzle is positioned within the filler neck. This is achieved by comparing the raw data gathered by the distance-measuring sensor against a preset distance threshold, which is one of the allowable conditions stored on the microprocessor. The preset distance threshold is the distance between the distance-measuring sensor and the fuel nozzle, when the fuel nozzle is positioned within the filler neck of the diesel vehicle. Additionally, the preset distance threshold is associated with the potential use of regular fuel within the diesel vehicle. The process for this embodiment includes capturing distance data value through the distance-measuring sensor during step (C). Then the distance data value is compared against the preset distance threshold in order to determine whether the fuel nozzle is positioned within the filler neck of the diesel vehicle. If the distance data value is less than the preset distance threshold, then the system generates the trigger command with the microprocessor during step (E) in order to signal the motorist of the potential use of regular fuel in the diesel vehicle. For example, when the motorist is not fueling the diesel vehicle and the gas tank door is closed, the distance-measuring sensor will capture the distance to a wall of the fuel filler housing that is directly opposite the distance-measuring sensor. For example, the distance between the distance-measuring sensor and the wall could be 4 inches, and the preset distance threshold could be 2 inches. When the fuel nozzle is positioned within the filler neck, the fuel nozzle will intercept the line of sight of the distance-measuring sensor, and this will cause the distance-measuring sensor to measure a distance that is less than four inches. If this measured distance is less than 2 inches, then this will cause the present invention to generate a trigger command and activate the alert device. Two main devices that may be used as the distance-measuring sensor component include an ultrasound sensor and a laser rangefinder, although alternative devices may be used as well.

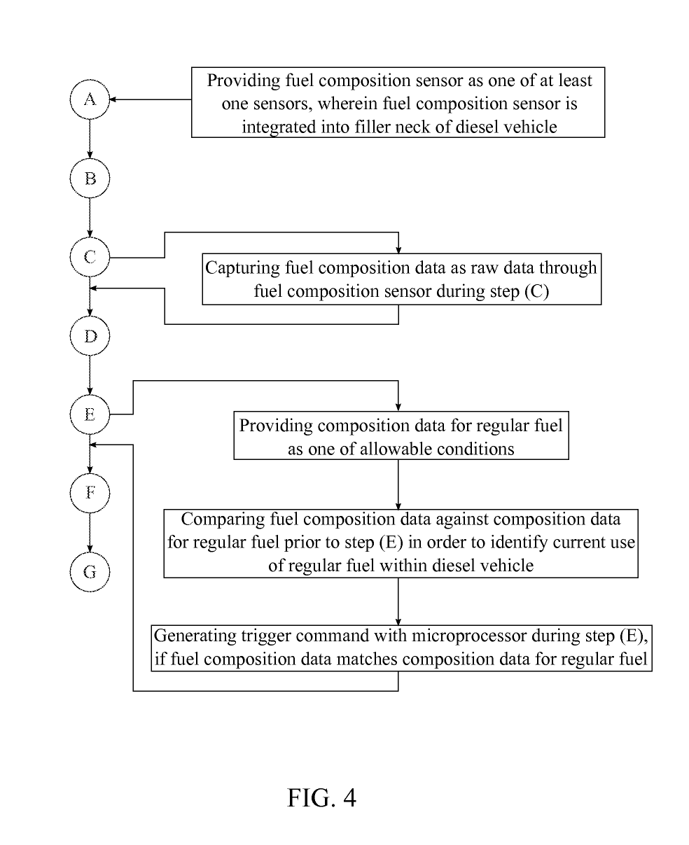

Referring to FIG. 4, in another embodiment of the present invention, the fuel composition sensor is used as one of the at least one sensors. In this embodiment, the fuel composition sensor is integrated into the filler neck of the diesel vehicle and is used to directly identify the fuel type being used to refuel the diesel vehicle. If the wrong fuel type is being used, the system signals a warning to the motorist. The process for this embodiment includes capturing fuel composition data as the raw data through the fuel composition sensor during step (C). Fuel composition data may include the chemical composition of the fuel, color of the fuel, and other descriptive information regarding the fuel being put into the diesel vehicle. The fuel composition data is then compared against a composition data for regular fuel, one of the allowable conditions stored on the microprocessor. The fuel composition data is compared against the fuel composition data for regular fuel prior to step (E) in order to identify the current use of regular fuel within the diesel vehicle. If the fuel composition data matches the composition data for regular fuel, then the system generates the trigger command with the microprocessor during the step (E) in order to signal the motorist of the current use of regular fuel within the diesel vehicle. A variety of devices may be used for the fuel composition sensor component.

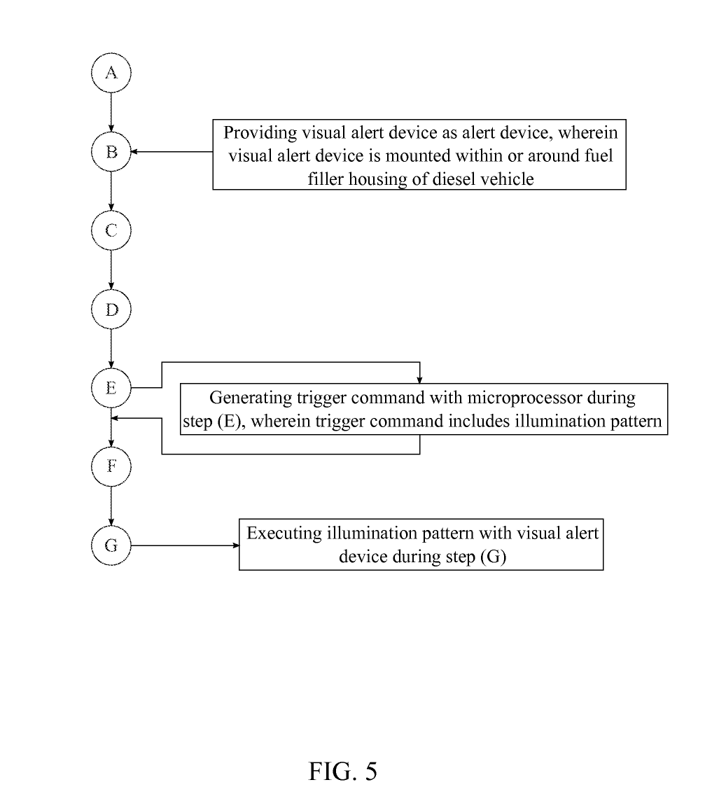

Referring to FIG. 5, in one embodiment of the present invention, a visual alert device is used as one of the at least one alert devices. Visual alert devices include, but are not limited to, a plurality of light emitting elements and a laser projector. The visual alert device is mounted within or around the fuel filler housing in plain view of the motorist when he or she is next to the gas tank. Alternative positioning may also be utilized for the present invention. An illumination pattern is generated during step (E) as part of the trigger command for the visual alert device. The illumination pattern is a set of commands which control the frequency, intensity, and other similar aspects of the visual alert device. If the sensor identifies the current use or potential use of regular fuel within the diesel vehicle, then the illumination pattern is executed during step (G) by the visual alert device in order to signal the motorist to notify the motorist that the diesel vehicle is being refueled with the wrong kind of fuel. For example, the plurality of light emitting elements can be lit up to spell out “Diesel Only” or simply illuminate an aperture that is shaped like “Diesel Only”. Another example is the laser projector being mounted on the inside of the gas tank door such that when the gas tank door is opened the laser projector is oriented towards a nearby surface of the diesel vehicle or around the diesel vehicle. When activated, the laser projector displays “Diesel Only” on the nearby surface of the diesel vehicle.

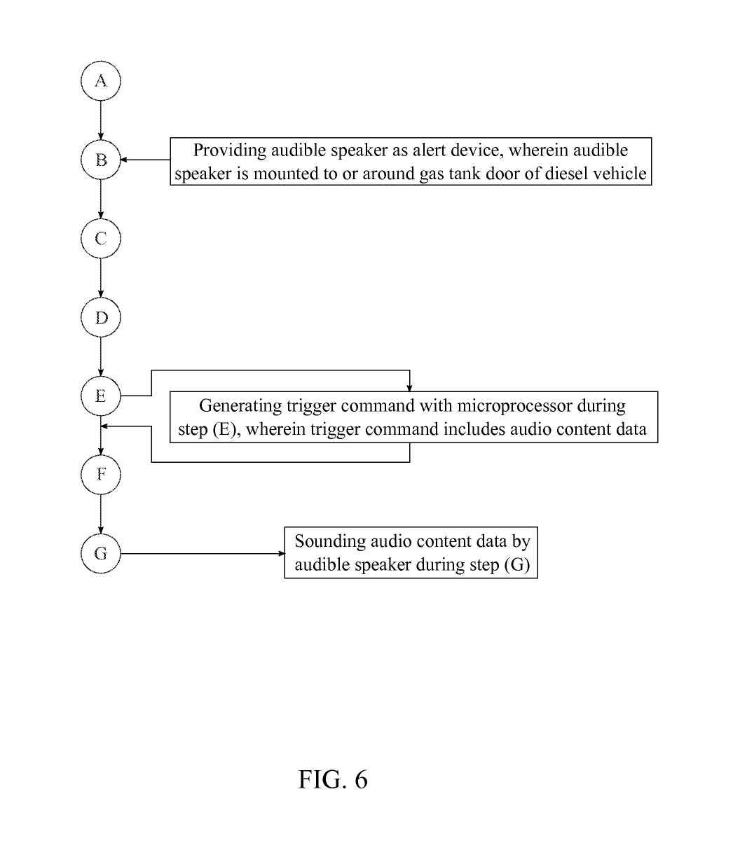

Referring to FIG. 6, in one embodiment of the present invention, an audible speaker is used as one of the at least one alert devices. The audible speaker is mounted to or around the gas tank door of diesel vehicle, either on the inside or on the outside. Alternative positioning may also be utilized for the present invention. Audio content data is generated during step (E) as part of the trigger command for the audible speaker. The audio content data includes, but is not limited to, tunes, songs, tones, and speech related audio. If the sensor identifies the current use or potential use of regular fuel within the diesel vehicle, then the audio content data is sounded by the audible speaker during step (G) in order notify the motorist that the diesel vehicle is being refueled with the wrong kind of fuel. For example, the present invention may sound the sentence “Only diesel fuel may be used for this vehicle” by the audible speaker in response to the trigger command being generated.

A variety of mounting mechanism may be used to mount for the constituents of the present invention to the diesel vehicle including, but not limited to, magnets, double-sided adhesives, bolts, screws, and factory integration. Additionally, the constituents of the present invention may be mounted in various location including, but not limited to, the gas fuel door, the fuel filler cap, the fuel filler tube, the fuel filler housing, or anywhere that the motorist fueling the diesel vehicle may be alerted.

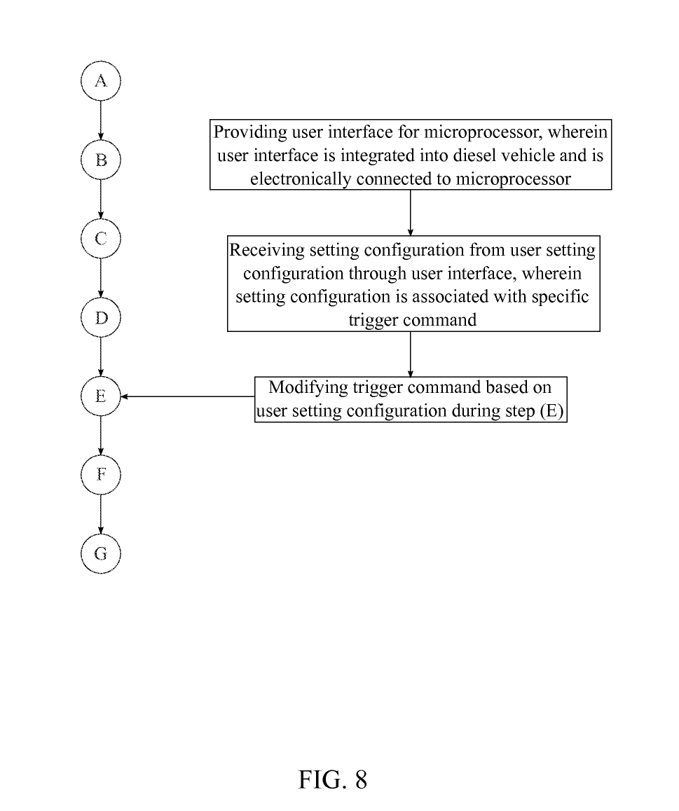

Referring to FIG. 8, the present invention may also utilize a user interface for the microprocessor in order to control the settings of the present invention. The user interface is integrated into the diesel vehicle and is electronically connected to the microprocessor. To alter the settings of the present invention, the motorist simply selects a user setting configuration through the user interface. The user setting configuration is associated with a specific trigger command. The trigger command is modified during step (E) based on the user setting configuration selected by the motorist. This allows the motorist to pick and choose which tones, tunes, or sounds are played by the audible speaker or what colors are displayed by the visual alert device. A variety of devices may be used for the user interface component. In one embodiment of the present invention, a plurality of buttons is used as the user interface.

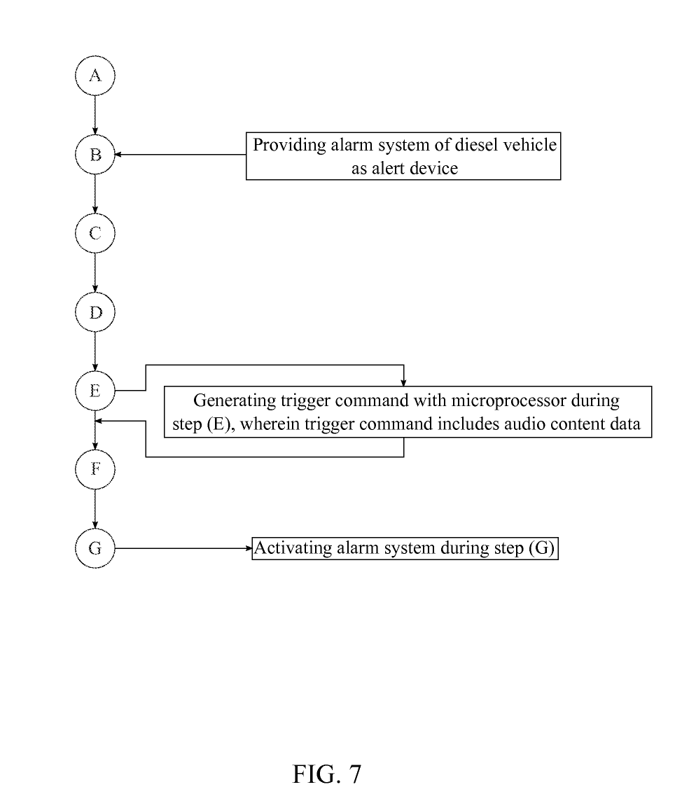

Referring to FIG. 7, in one embodiment, an alarm system of the diesel vehicle is used as one of the at least one alert devices. The alarm system is activated during step (G) in response to the trigger command being generated. The present invention may be used in a variety of automotive vehicle types including, but not limited to, sedans, minivans, trucks, limousines, and vans. Additionally, the present invention may be configured for a variety of fuel types including, but not limited to, diesel, gasoline, and ethanol.

In one embodiment, the present invention utilizes the plurality of light emitting elements in conjunction with the light sensor for the alert device and the sensor, respectively. The plurality of light emitting elements, the power source, the light sensor, and the microprocessor are housed by a main body. The main body is mounted to the inside of the gas tank door through double sided adhesive strips. Additionally, a plurality of buttons is integrated into the main body and serve as the user interface for the motorist. The plurality of light emitting elements is positioned to protrude partially from the main housing. When the gas tank door is opened, the light sensor activates the plurality of light emitting elements and signals to the motorist of the potential use of regular fuel within the diesel vehicle.

Although the invention has been explained in relation to its preferred embodiment, it is to be understood that many other possible modifications and variations can be made without departing from the spirit and scope of the invention as hereinafter claimed.

What is claimed is:

1. A method for a vehicle misfuelling alert system comprises the steps of:
(A) providing an at least one sensor integrated or mounted into a diesel vehicle, wherein the sensor indicates a current use or potential use of regular fuel within the diesel vehicle;
(B) providing at least one alert device integrated into the diesel vehicle, wherein the alert device is electronically connected to the sensor through a microprocessor;
(C) capturing raw data through the sensor, wherein the raw data corresponds to the current use or potential use of regular fuel within the diesel vehicle;
(D) sending the raw data from the sensor to the microprocessor, wherein the microprocessor stores allowable conditions for refueling the diesel vehicle:
(E) generating a trigger command with the microprocessor, if the raw data does not match the allowable conditions for refueling the diesel vehicle;
(F) sending the trigger command from the microprocessor to the alert device; and
(G) executing the trigger command with the alert device.

2. The method for a vehicle misfuelling alert system as claimed in claim 1 comprises the steps of:
providing a light sensor as one of the at least one sensors, wherein the light sensor is mounted within a fuel filler housing of the diesel vehicle;
providing a preset lux threshold as one of the allowable conditions, wherein the preset lux threshold is associated with an ajar status for a gas tank door of the fuel filler housing and is further associated with the potential use of regular fuel within the diesel vehicle;
capturing a lux data value as the raw data through the light sensor during step (C); and
generating the trigger command with the microprocessor during step (E), if the lux data value is greater than the preset lux threshold.

3. The method for a vehicle misfuelling alert system as claimed in claim 1 comprises the steps of:
providing a distance-measuring sensor as one of the at least one sensors, wherein the distance-measuring sensor is mounted within a fuel filler housing of the diesel vehicle, adjacent to a filler neck of the diesel vehicle;
providing the distance-measuring sensor is oriented across an opening of the filler neck;
providing a preset distance threshold as one of the allowable conditions, wherein the preset distance threshold is associated with a fuel nozzle being positioned within the filler neck and is further associated with the potential use of regular fuel within the diesel vehicle;
capturing distance data value as the raw data through the distance-measuring sensor during step (C); and
generating the trigger command with the microprocessor during step (E), if the distance data value is less than the preset distance threshold.

4. The method for a vehicle misfuelling alert system as claimed in claim 3, wherein the distance-measuring sensor is an ultrasound sensor.

5. The method for a vehicle misfuelling alert system as claimed in claim 3, wherein the distance-measuring sensor is a laser rangefinder.

6. The method for a vehicle misfuelling alert system as claimed in claim 1 comprises the steps of:
providing a fuel composition sensor as one of the at least one sensors, wherein the fuel composition sensor is integrated into a filler neck of the diesel vehicle;
providing a composition data for regular fuel as one of the allowable conditions;
capturing fuel composition data as the raw data through the fuel composition sensor during step (C);
comparing the fuel composition data against the composition data for regular fuel prior to step (E) in order to identify the current use of regular fuel within the diesel vehicle; and
generating the trigger command with the microprocessor during step (E), if the fuel composition data matches the composition data for regular fuel.

7. The method for a vehicle misfuelling alert system as claimed in claim 1 comprises the steps of:
providing a visual alert device as the alert device, wherein the visual alert device is mounted within or around a fuel filler housing of the diesel vehicle;
generating a trigger command with the microprocessor during step (E), wherein the trigger command includes an illumination pattern; and
executing the illumination pattern with the visual alert device during step (G).

8. The method for a vehicle misfuelling alert system as claimed in claim 7, wherein the visual alert device includes a plurality of light emitting elements.

9. The method for a vehicle misfuelling alert system as claimed in claim 7, wherein the visual alert device includes a laser projector.

10. The method for a vehicle misfuelling alert system as claimed in claim 1 comprises the steps of:
providing an audible speaker as the alert device, wherein the audible speaker is mounted to or around a gas tank door of the diesel vehicle;
generating the trigger command with the microprocessor during step (E), wherein the trigger command includes audio content data; and
sounding the audio content data by the audible speaker during step (G).

11. The method for a vehicle misfuelling alert system as claimed in claim 1 comprises the steps of:
providing an alarm system of the diesel vehicle as the alert device; and
activating the alarm system during step (G).

12. The method for a vehicle misfuelling alert system as claimed in claim 1 comprises the steps of:
providing a user interface for the microprocessor, wherein the user interface is integrated into the diesel vehicle and is electronically connected to the microprocessor;
receiving a setting configuration from a user setting configuration through the user interface, wherein the setting configuration is associated with a specific trigger command; and
modifying the trigger command based on the user setting configuration during step (E).
